(19) United States
(12) Patent Application Publication
(10) Pub. No.: US 2022/0324028 A1
(43) Pub. Date: Oct. 13, 2022

(54) ADDITIVE MANUFACTURING METHOD

(71) Applicant: AddUp, Cebazat (FR)

(72) Inventors: MICHEL RUIZ, CEBAZAT (FR); ALEXIS PICARD, Cebazat (FR); ANTHONY AUBRUN, Cebazat (FR)

(21) Appl. No.: 17/763,951

(22) PCT Filed: Sep. 25, 2020
(86) PCT No.: PCT/FR2020/051674

§ 371 Date: Mar. 25, 2022

(30) Foreign Application Priority Data
Sep. 27, 2019 (FR) FR1910687

(51) Int. Cl. B22F 10/47

(52) U.S. Cl. CPC B22F 10/47; B33Y 80/00

(57) ABSTRACT

The present invention relates to an additive manufacturing support (1) comprising, on a plate of an additive manufacturing machine, a stack produced by additive manufacturing, having:
on the one hand, a breakable zone with a structure suitable for holding, during its manufacture, a part (100) intended to be produced by additive manufacturing, and
on the other hand, between the plate and the zone with a breakable structure, an intermediate zone with a porous structure.

### FIELD OF THE INVENTION

The present invention relates to the field of additive manufacturing and more particularly to the additive manufacturing of parts having a return.

### PRIOR ART

In a known manner, additive manufacturing consists in manufacturing a part by successive superposition of layers of powder that are locally melted.

More specifically, additive manufacturing consists in creating three-dimensional objects by consolidating selected zones in successive layers of pulverulent material (metal powder, ceramic powder, etc.). The consolidated zones correspond to successive cross sections of the three-dimensional object. Consolidation takes place for example layer by layer, through total or partial selective melting carried out using a consolidation source (a high-power laser beam, an electron beam, etc.).

This manufacturing method makes it possible to produce structures that are impossible to manufacture with traditional methods (machining, moulding).

In particular, additive manufacturing makes it possible to produce parts having tapers and undercuts, that is to say parts having opposite convex geometric shapes, which are impossible to produce by moulding and very difficult to produce by machining.

Additive manufacturing also makes it possible to produce lattice structures that cannot be manufactured otherwise.

In addition, this manufacturing method can prove to be rapid and relatively inexpensive, and this allows it to be used in the context of rapid prototyping, instead of, for example, high-speed machining, which remains complex.

In additive manufacturing, the part is produced by successively stacking layers. Depending on the orientation of the geometry, it is sometimes necessary to start the manufacture by producing a support on which the part is manufactured. In the case in which the part includes a return, that is to say a part overhanging from the rest of the part, it is necessary to provide a support under this return. However, manufacturing a support is a time-consuming operation.

As a result, the objective of the present invention is to provide an additive manufacturing support that can be produced quickly and inexpensively.

### SUMMARY OF THE INVENTION

According to a first aspect, the invention proposes an additive manufacturing support comprising, on a plate of an additive manufacturing machine, a stack produced by additive manufacturing, having:
on the one hand, a breakable zone with a structure suitable for holding, during its manufacture, a part intended to be produced by additive manufacturing, and
on the other hand, between the plate and the zone with a breakable structure, an intermediate zone with a porous structure.

The breakable zone may have a lamellar structure.

The intermediate zone may have a porosity of between 0.5 and 5%, preferentially between 1 and 2%.

The support may further comprise an anchoring zone, which is suitable for being attached to a manufacturing plate. The anchoring zone may have a density greater than the density of the porous intermediate zone and/or of the breakable zone.

The breakable zone may have a thickness less than 15% of a total thickness of the support.

The intermediate zone may have a thickness of between 60% and 95% of a total thickness of the support.

The anchoring zone may have a thickness less than or equal to 30% of a total thickness of the support.

According to a second aspect, the invention relates to a method for the additive manufacturing of a part by consolidation of selected zones on successive layers of a pulverulent material, by a consolidation source, wherein an additive manufacturing support is produced beforehand by additive manufacturing, on a plate of an additive manufacturing machine, of a stack comprising:
on the one hand, a breakable zone with a structure suitable for holding, during its manufacture, a part intended to be produced by additive manufacturing, and
on the other hand, between the plate and the zone with a breakable structure, an intermediate zone with a porous structure.

The breakable zone may be a zone with a lamellar structure produced with an energy density of between 10% and 25%, preferentially 14 and 20%, of the energy density per unit volume during the manufacture of the part.

The space between the vectors during the manufacture of the breakable zone may be between 300 and 500% of the space between the vectors during the manufacture of the part.

The porous intermediate zone may be produced with an energy density per unit volume of between 15% and 60%, preferentially 22 and 50%, of the energy density per unit volume of the energy density per unit volume during the manufacture of the part.

The space between the vectors during the manufacture of the porous zone may be between 130 and 190% of the space between the vectors during the manufacture of the part.

The energy density per unit volume during the manufacture of the anchoring zone may be between 90% and 110% of the energy density per unit volume used during the manufacture of the part.

### DESCRIPTION OF THE FIGURES

Further features, objects and advantages of the invention will become apparent from the following description, which is purely illustrative and non-limiting and should be read in conjunction with the appended drawing, in which:

FIG. 1 is a cross-sectional depiction of a support according to the invention.

FIG. 2 is a schematic depiction of a path of a consolidation source during the manufacture of a breakable zone according to a first example.

FIG. 3 is a schematic depiction of a path of a consolidation source during the manufacture of a breakable zone according to a second example.

FIG. 4 is a schematic depiction of a path of a consolidation source during the manufacture of a breakable zone according to a third example.

FIG. 5 is a schematic depiction of a path of a consolidation source during the manufacture of a breakable zone according to a fourth example.

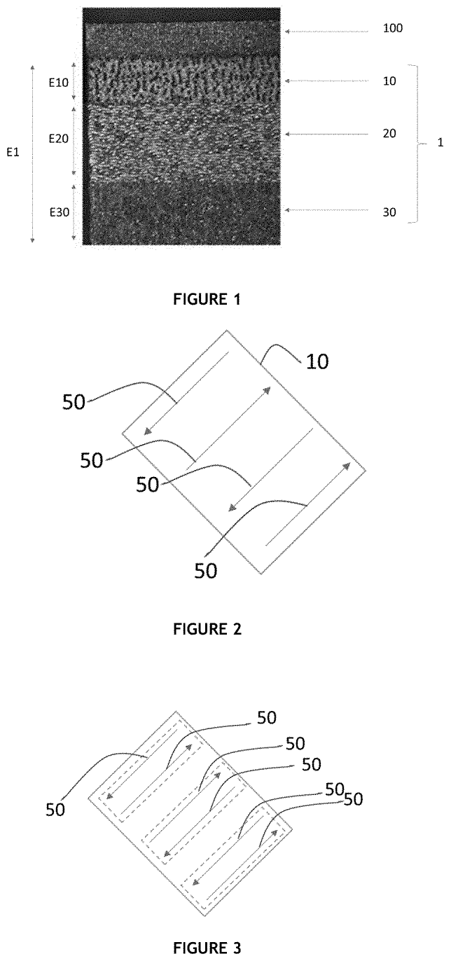

### DETAILED DESCRIPTION OF THE INVENTION

According to a first aspect, the invention relates to an additive manufacturing support 1 comprising a stack of a plurality of zones produced by additive manufacturing, including at least one zone having a breakable structure and at least one zone having a porous structure. Typically, according to the embodiment presented here, the support 1 comprises three distinct structures: a breakable zone 10, an intermediate zone 20 manufactured with a low energy density and an anchoring zone 30.

The stack that constitutes the support 1 is produced by additive manufacturing by deposition of successive powder beds starting from an additive manufacturing machine plate and consolidation (sintering and/or melting) of selected zones on the successively deposited layers of pulverulent material.

On the stack, the various zones that succeed one another along the (vertical) manufacturing axis are consolidated layers of material that extend transversely with respect to said axis and have, from one zone to another, different structures.

According to the embodiment presented here, the support 1 comprises, successively, starting from the plate of an additive manufacturing machine: the anchoring zone 30, then the porous zone 20, then the breakable zone 10. As a variant, the support 1 can comprise only, starting from the plate of an additive manufacturing machine: the porous zone 20 with low energy density and the breakable zone 10.

### Breakable Zone 10

The breakable zone 10 has a structure:
on the one hand that allows it to secure the part 100 during its manufacture according to a method of additive manufacturing by powder bed deposition and
on the other hand that allows it to separate the part 100 from the support 1 and the plate of the additive manufacturing machine.

According to an advantageous arrangement, the breakable zone 10 has a lamellar structure (from a macroscopic point of view).

A lamellar structure is understood to mean a structure made up of a plurality of lamellae that are substantially parallel to one another.

The lamellar structure of said zone 10 is aerated and has a large specific surface area. It has gaps between the lamellae, and this allows the structure to have a reduced density. In other words, the breakable zone 10 has a structure similar to a foam, i.e. a structure comprising cavities (i.e. bubbles) separated by a rigid mass.

More specifically, the lamellar structure comprises a plurality of solid portions spaced apart from one another. In other words, the solid portions are a definition of the lamellar structure. These solid portions correspond to discrete conglomerates of molten powder. In other words, during the manufacture of the breakable zone, a consolidation source of an additive manufacturing machine will discontinuously melt the powder along its path (as shown in FIGS. 2 to 5). The breakable zone therefore comprises a multitude of solid portions that do not belong to one and the same block, as opposed to a porous part made in one piece.

According to a particular arrangement, the solid portions of the breakable zone 10 have a polygonal section and/or a curvilinear section. Typically, the solid portions can be triangular or rectangular, or circular, lamellae. In addition, these lamellae can be straight or wave-shaped.

Each solid portion of the breakable zone 10 can have an area of less than 10%, and preferentially between 1% and 5%, of an area of the breakable zone 10. This arrangement makes it possible to ensure optimal holding of the part during its manufacture and optimal breakability during the extraction of the part.

According to a particular arrangement, a sum of the areas of the solid portions can be between 30% and 75% of the area of the breakable zone 10.

The gap between lamellae is the result of an increase of between 300 and 500% of the vector distance between two scans of the beam of the energy source compared with that used to produce the reference structure that is the anchoring zone. This arrangement does not allow an overlap between the melting/sintering baths. The result obtained is, for example, in the form of independent lamellae.

This arrangement allows the breakable zone 10 to have a structure that is sufficiently resistant to the forces generated during manufacture, while at the same time exhibiting a fragility linked to its fine structure that makes it possible to easily separate the part 100 manually and thus makes it possible to make the separation between the part 100 and the porous zone 20 easier.

The breakable zone 10 has for example a thickness E10 less than 15% of a total thickness E1 of the support 1. Preferentially, the thickness E10 is less than or equal to 10% of the total thickness E1. Particularly preferentially, the thickness E10 is between 5% and 10% of the total thickness E1.

### Intermediate Zone 20

The zone 20 is produced using a reduced energy density per unit volume during the melting or sintering by scans of the beam of the energy source of the additive manufacturing machine.

A consequence of this reduced energy density is that the structure of zone 20 is porous.

This porous structure 20 allows sufficient strength to withstand the forces associated with manufacture.

Typically, the zone 20 has a porous structure of which the porosity is between 0.5 and 5%, preferentially between 1 and 2%. It is recalled that the percentage of porosity of a structure is the ratio between the voids volume and the total volume of the porous structure.

According to a particular arrangement, the intermediate zone 20 has a thickness E20 of between 60% and 95% of the total thickness E1 of the support 1.

Preferentially, the thickness E20 is between 70% and 90% of the total thickness E1 of the support 1.

### Anchoring Zone 30

According to the embodiment presented here, the support 1 has an anchoring zone 30. This is an advantageous arrangement; according to other embodiments, the support 1 could have only a breakable zone 10 and an intermediate zone 20.

The anchoring zone 30 is intended to ensure good attachment of the support 1 to a manufacturing plate of an additive manufacturing machine.

Preferentially, the anchoring zone 30 is produced with an energy density per unit volume substantially similar to that used to produce the part 100. This arrangement allows the anchoring zone 30 to be particularly strong and to be attached to a plate of an additive manufacturing machine.

According to a particular arrangement, the anchoring zone 30 has a thickness E30 less than 30% of a total thickness E1 of the support 1. Preferentially, the thickness E30 is less than or equal to 20% of the total thickness E1.

### Manufacturing Method

According to a second aspect, the invention proposes a method for the additive manufacturing of a part 100.

Additive manufacturing is, for example, understood to mean a method of manufacturing by powder bed deposition in which layers of powder are superposed. Then, each layer of powder is locally melted according to the plane of the part 100 to be manufactured (in a conventional manner, the melting can be carried out by an electron beam or a laser). The part 100 is thus manufactured by incrementation, i.e. a superposition of various layers.

According to an accepted definition, additive manufacturing by powder bed deposition consists in creating three-dimensional objects by consolidating selected zones in successive layers of pulverulent material (metal powder, ceramic powder, etc.). The consolidated zones correspond to successive cross sections of the three-dimensional object. Consolidation takes place for example layer by layer, through total or partial selective melting carried out using a consolidation source (a high-power laser beam, an electron beam, etc.).

According to a particularly advantageous arrangement, the method begins with the manufacture of the support 1 and optionally of the part 100.

The stacked zones of the support 1 are produced in the following order: anchoring zone 30 (if appropriate), then intermediate zone 20 and breakable zone 10.

According to a particularly advantageous technical arrangement, the consolidation step comprises a supply of energy corresponding to an energy density per unit volume that is determined as follows:

$$Energy density per unit volume ( J \cdot {cm}^{- 3} ) = \frac{Power ( W )}{S p e e d ( cm \cdot {s}^{- 1} ) \cdot Spαce between the vectors ( cm ) \cdot Layer thickness ( cm )}$$

with the speed corresponding to the speed of movement of the consolidation source and the space between the vectors corresponding to the distance between two vectors of the path of the beam of the consolidation source.

It is remarkable that the variation in the energy density per unit volume makes it possible to vary the structure of the material shaped by additive manufacturing.

In other words, by modifying the energy density per unit volume and in particular by modifying the vector distance, it is possible to create a dense, porous or lamellar structure. Typically, but not limitingly, the space between the vectors for producing the anchoring zone is between 30 and 100 μm. In order to create the porous structure, this parameter can be increased by between 130 and 200%. In order to create the lamellar structure, this same parameter can be increased by between 300 and 500%.

Preferentially, with a view to saving production time, the energy density per unit volume is modified by varying the space between the vectors. Specifically, the parameter of the space between the vectors corresponds to the distance between two successive scans, and can be easily increased without prejudice to the duration of production of the part 100

It is nevertheless possible to vary the energy density per unit volume by modifying the other parameters, namely the power of the source, the speed of movement of the source and the layer thickness of the additive manufacturing powder.

In a particularly advantageous manner, considering as a reference the energy density per unit volume necessary to manufacture the part, the energy density per unit volume necessary to manufacture the breakable zone 10 is between 10% of the energy density per unit volume necessary to manufacture the part and 25% of the energy density per unit volume necessary to manufacture the part 100.

Preferentially, the energy density per unit volume necessary to manufacture the breakable zone 10 is between 14% of the energy density per unit volume necessary to manufacture the part and 20% of the energy density per unit volume necessary to manufacture the part 100.

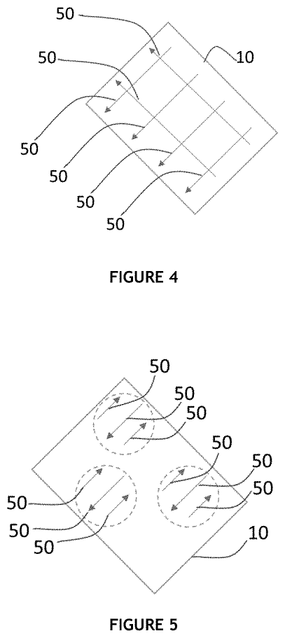

In addition, as shown in FIGS. 2 to 5, in order to manufacture the solid portions that constitute the lamellar structure, the consolidation source intermittently emits a beam of energy. Thus, with reference to FIGS. 2 to 5, the vectors 50 represent the paths along which the consolidation source emits a beam (and therefore melts the powder). FIG. 4 represents a stack of crossed lamellae that are oriented orthogonally. Thus the paths of the vectors 50 intersect in a planar depiction.

According to an advantageous arrangement, the energy density per unit volume necessary to manufacture the intermediate zone 20 may be between 15% of the energy density per unit volume necessary to manufacture the part and 60% of the energy density per unit volume necessary to manufacture the part 100.

Preferentially, the energy density per unit volume necessary to manufacture the intermediate zone 20 may be between 22% of the energy density per unit volume necessary to manufacture the part and 50% of the energy density per unit volume necessary to manufacture the part 100.

According to an advantageous arrangement, the energy density per unit volume necessary to manufacture the anchoring zone 30 is substantially equal to the energy density per unit volume necessary to manufacture the part 100 (to within plus or minus 10%).

1.-14. (canceled)

15. An additive manufacturing support (1) comprising, on a plate of an additive manufacturing machine, a stack produced by additive manufacturing, having:
a breakable zone (10) with a lamellar structure comprising a plurality of solid portions spaced apart from one another, the breakable zone (10) being suitable for holding, during its manufacture, a part (100) intended to be produced by additive manufacturing; and
between the plate and the breakable zone (10), an intermediate zone with a porous structure (20).

16. The additive manufacturing support (1) according to claim 15, wherein the solid portions of the breakable zone (10) have a polygonal section and/or a curvilinear section.

17. The additive manufacturing support (1) according to claim 15, wherein each solid portion of the breakable zone (10) has an area of less than 10% of an area of the breakable zone (10).

18. The additive manufacturing support (1) according to claim 17, wherein a sum of the areas of the solid portions is between 30% and 75% of the area of the breakable zone (10).

19. The additive manufacturing support (1) according to claim 15, wherein the intermediate zone has a porosity of between 0.5 and 5%.

20. The additive manufacturing support (1) according to claim 15, further comprising an anchoring zone (30), which is suitable for being attached to a manufacturing plate, the anchoring zone (30) having a density greater than a density of the porous intermediate zone (20) and/or of the breakable zone (10).

21. The additive manufacturing support (1) according to claim 15, wherein the breakable zone has a thickness less than 15% of a total thickness of the support.

22. The additive manufacturing support (1) according to claim 15, wherein the intermediate zone (20) has a thickness of between 60% and 95% of a total thickness of the support (1).

23. The additive manufacturing support (1) according to claim 20, wherein each solid portion of the breakable zone (10) has an area of less than 10% of an area of the breakable zone (10), and
wherein the anchoring zone (30) has a thickness less than or equal to 30% of a total thickness of the support.

24. A method for the additive manufacturing of a part (100) by consolidation of selected zones on successive layers of a pulverulent material, by a consolidation source, comprising:
producing an additive manufacturing support (1) beforehand by additive manufacturing, on a plate of an additive manufacturing machine, of a stack comprising:
a breakable zone with a lamellar structure suitable for holding, during its manufacture, the part (100) intended to be produced by additive manufacturing, produced with an energy density of between 10% and 25% of the energy density per unit volume during the manufacture of the part (100), and
between the plate and the breakable zone, an intermediate zone with a porous structure.

25. The method according to claim 24, wherein a space between vectors during the manufacture of the breakable zone is between 300 and 500% of a space between vectors during the manufacture of the part.

26. The method according to claim 24, wherein the porous intermediate zone (20) is produced with an energy density per unit volume of between 15% and 60% of the energy density per unit volume of the energy density per unit volume during the manufacture of the part (100).

27. The method according to claim 26, wherein a space between vectors during the manufacture of the porous zone is between 130 and 190% of a space between vectors during the manufacture of the part.

28. The method according to claim 24, wherein an energy density per unit volume during the manufacture of an anchoring zone (30) is between 90% and 110% of an energy density per unit volume used during the manufacture of the part (100).
